(19) United States
(12) Patent Application Publication
(10) Pub. No.: US 2008/0208878 A1
(43) Pub. Date: Aug. 28, 2008

(54) Computer-readable recording medium recording file processing program, and file processing method and apparatus, and computer-readable recording medium recording functional program

(75) Inventors: Hiroyuki Komori, Kawasaki (JP); Toshimasa Suzuki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/071,715

(22) Filed: Feb. 25, 2008

(30) Foreign Application Priority Data
Feb. 27, 2007 (JP) 2007-048041

(51) Int. Cl. G06F 17/30

(52) U.S. Cl. 707/100; 707/E17.001

(57) ABSTRACT

Disclosed is a computer-readable recording medium recording a file processing program capable of achieving reduction of a processing time. A notifying section sequentially notifies, based on information acquisition instructions from an application, the application of a plurality of data blocks stored in a storing section. An identifier grasping section refers to identifiers of the respective data blocks stored in the storing section and grasps an identifier corresponding to a data block currently notified of by the notifying section. An executing section receives, when the notifying section notifies the application of the plurality of data blocks, data execution instructions from the application and reads out and executes a data block corresponding to an identifier most recently grasped by the identifier grasping section.

### CROSS-REFERENCE TO RELATED APPLICATIONS

This application is based upon and claims the benefits of priority from the prior. Japanese Patent Application No. 2007-048041, filed on Feb. 27, 2007, the entire contents of which are incorporated herein by reference.

### BACKGROUND OF THE INVENTION

1. Field of the Invention

The present invention relates to computer-readable recording media recording a file processing program, and file processing methods and apparatuses, and computer-readable recording media recording a functional program. More particularly, the present invention relates to a computer-readable recording medium recording a file processing program, and file processing method and apparatus, and computer-readable recording medium recording a functional program applied to a file system.

2. Description of the Related Art

A file system used in an apparatus such as a digital still camera generally provides a function of opening a file for storing data as a file in a medium (storage device such as a Hard Disk Drive (HDD) or portable memory) or for referring to a stored file (see, e.g., Japanese Unexamined Patent Application Publication Nos. Hei 7-105064 and Hei 5-324435). Further, a file system provides a function of referring to file information within a directory (also called as a folder). An application performs management and operation of data using these functions of a file system.

Embedded devices such as digital still cameras are characteristically required that when a user sequentially refers to image files, the image files can be opened without regard to file names. At the same time, in order to open a file, a name of the file (it means a file name, that is, a full name) is generally required in the file system.

However, saving of memory capacity may be required in the case of the embedded device. Accordingly, a method of establishing rules on the name of a file used by an application and storing in a memory not the whole but only a part of the name to discriminate files is performed to save the memory capacity. In that case, in order for the application to open a file using a part of a file name stored in the memory, it is required to obtain a file name (a full name) based on a part of the file name and then to perform processing (open processing) for opening the file. In order to obtain the file name, processing (directory reference processing) for sequentially referring to (retrieving) file information (name, attribute and date) stored in a directory and matching the information with a part of the file name is performed. Then, the file open processing is performed by specifying the matched file name. Also in the open processing, file information is further retrieved from the specified file name.

Thus, in the conventional processing, when the open processing is performed after the directory reference processing, the file system ends up performing twice the retrieval of file information. Further, a bunch of file information on a medium is read in a RAM (Random Access Memory) as a cache memory to speed up an access to file information. In the case where the cache capacity is small, however, there is a high possibility that when the retrieval is performed twice, a content of the cache is flashed (written back). As a result, an access to medium unnecessarily occurs. Accordingly, the conventional processing is inefficient and has an influence on a processing time of CPU (Central Processing Unit).

### SUMMARY OF THE INVENTION

According to one aspect of the present invention, there is provided a computer-readable recording medium recording a file processing program applied to a file system. The file processing program causes a computer to function as: a notifying section which sequentially notifies, based on data acquisition instructions from an application, the application of a plurality of data blocks stored in a storing section; an identifier grasping section which refers to identifiers of the respective data blocks stored in the storing section and grasps an identifier corresponding to a data block currently notified by the notifying section; and an executing section which, when the notifying section notifies the application of the plurality of data blocks, receives data execution instructions from the application and reads out and executes a data block corresponding to an identifier most recently grasped by the identifier grasping section.

According to another aspect of the present invention, there is provided a computer-readable recording medium recording a functional program applied to a file system. The functional program causes a computer to function as: outputting section which, in open processing executed in a state where based on data acquisition instructions from an application a plurality of data blocks stored in storing section are sequentially notified to the application, identifiers of the respective data blocks stored in the storing section are referenced and an identifier corresponding to a data block currently notified to the application is grasped, outputs as a return value a data block corresponding to a most recently grasped identifier, the open processing being executed based on a function call from the application when the plurality of data blocks are sequentially notified to the application.

### BRIEF DESCRIPTION OF THE DRAWINGS

FIG. 1 shows an outline of the present invention.

FIG. 2 shows a hardware configuration example of a file processing apparatus.

FIG. 3 is a block diagram showing functions of the file processing apparatus.

FIG. 4 shows operations of the file processing apparatus.

FIG. 5 is a flowchart showing directory reference processing and open processing of an object file.

FIG. 6 shows a use image of a function.

### DESCRIPTION OF THE PREFERRED EMBODIMENTS

Preferred embodiments of the present invention will be described in detail below with reference to the accompanying drawings, wherein like reference numerals refer to like elements throughout.

First, an outline of the present invention will be described and then, the embodiments will be described.

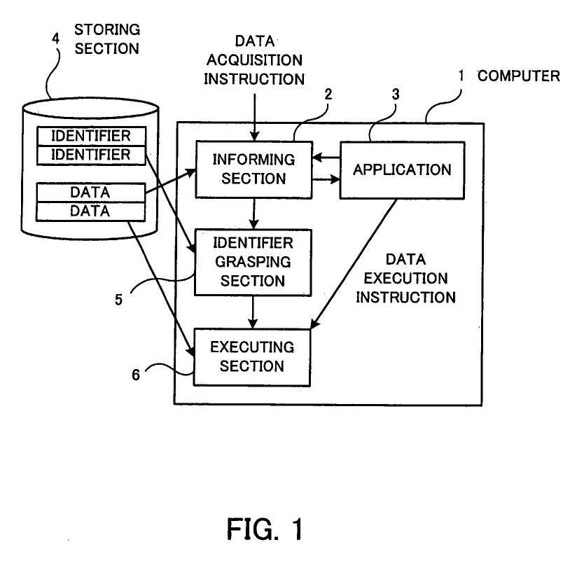

FIG. 1 shows an outline of the present invention.

By execution of a file processing program, a computer 1 functions as a notifying section 2, an identifier grasping section 5 and an executing section 6. The computer 1 further has an application 3.

The notifying section 2 sequentially notifies, based on information acquisition instructions from the application 3, the application 3 of a plurality of data blocks stored in a storing section 4.

The identifier grasping section 5 refers to identifiers of the respective data blocks stored in the storing section 4 and grasps an identifier corresponding to a data block currently notified by the notifying section 2.

The executing section 6 receives, when the notifying section 2 notifies the application 3 of data blocks, data execution instructions from the application 3 and reads out and executes a data block corresponding to an identifier most recently grasped by the identifier grasping section 5.

Thus, according to the file processing program, the notifying section 2 sequentially notifies, based on information acquisition instructions from the application 3, the application 3 of a plurality of data blocks stored in a storing section 4. The identifier grasping section 5 refers to identifiers of the respective data blocks stored in the storing section 4 and grasps an identifier corresponding to a data block currently notified by the notifying section 2. The executing section 6 receives, when the notifying section 2 notifies the application 3 of data blocks, data execution instructions from the application 3 and reads out and executes a data block corresponding to an identifier most recently grasped by the identifier grasping section 5.

The embodiment of the present invention will be described below.

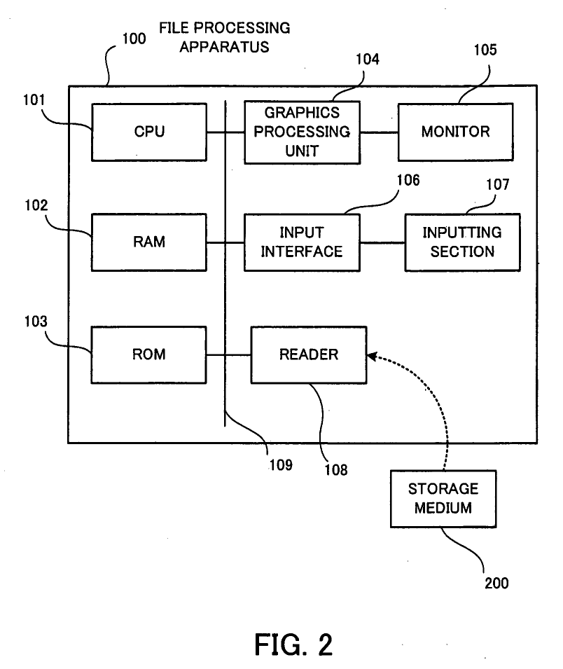

FIG. 2 shows a hardware configuration example of a file processing apparatus.

The whole of a file processing apparatus 100 is controlled by a CPU 101. A RAM 102, a ROM (Read Only Memory) 103, a graphics processor 104, an input interface 106 and a reader (a storage medium reading part) 108 are connected to the CPU 101 via a bus 109.

The RAM 102 temporarily stores at least a part of OS (Operating System) programs and application programs executed by the CPU 101. The RAM 102 also stores various data necessary for processing by the CPU 101. The ROM 103 stores OS, file system (middleware) and application programs, and a part of a file name (after-mentioned).

A monitor 105 is connected to the graphics processor 104. In accordance with instructions from the CPU 101, the graphics processor 104 displays images on the screen of the monitor 105. An inputting section 107 having, e.g., an arrow key or button is connected to the input interface 106. The input interface 106 transmits, to the CPU 101 via the bus 109, signals transmitted from the inputting section 107.

The reader 108 is provided to connect to an external storage medium 200. With the storage medium 200 connected to the reader 108, the CPU 101 can read a content of the storage medium 200 via the reader 108.

The storage medium 200 is detachably connected to the file processing apparatus 100 (the reader 108).

By the above-described hardware configuration, processing functions of the present embodiment can be realized. To perform file processing in a system having such a hardware configuration, the following functions are provided within the file processing apparatus 100.

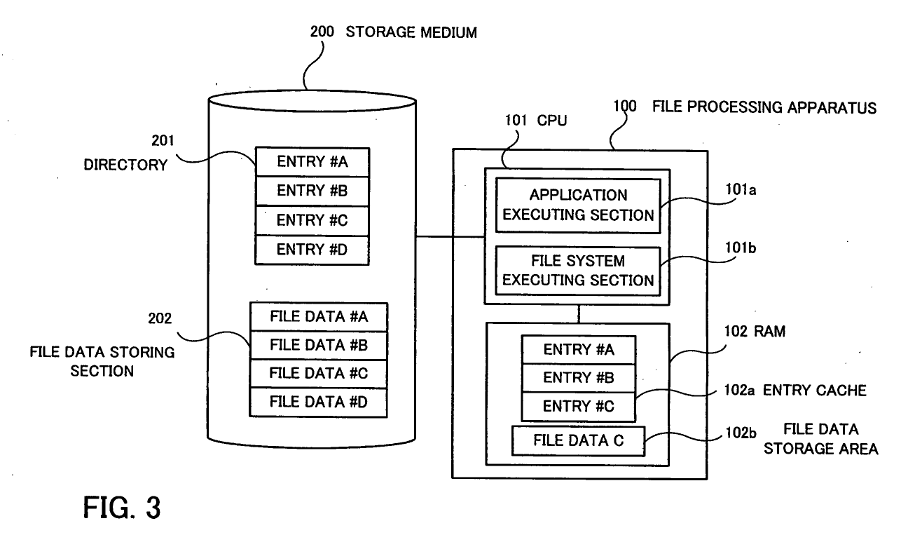

FIG. 3 is a block diagram showing functions of the file processing apparatus.

The CPU 101 has an application executing section 101a and a file system executing section 101b.

The application executing section (application) 101a executes an application program stored in the ROM 103, for example, when receiving an image display request sent from the inputting section 107 by the operation of an arrow key or button by a user.

The file system executing section 101b executes a file system stored in the ROM 103 with the execution of the application program by the application executing section 101a. This processing will be described later.

This file system executing section 101b forms a principal part of the notifying section, the identifier grasping section and the executing section.

The RAM 102 has an entry cache 102a and a file data storage area 102b.

The entry cache 102a temporarily stores as many entries as the number of those storable in the cache 102a, which are read by the file system executing section 101b. In FIG. 3, entries #A, #B and #C are stored in the cache 102a.

The file data storage area 102b stores data of a file to be opened by after-mentioned open processing.

The storage medium 200 has a directory 201 and a file data storing section 202.

The directory 201 stores entries #A to #D. The respective entries individually have information necessary for opening the respectively corresponding files, for example, identifiers indicating a name and date of a file, and a position of file data. For example, the entry #A has an identifier of file data #A.

The file data storing section 202 stores, for example, file data #A to #D as image files of images photographed by a user using the file processing apparatus 100.

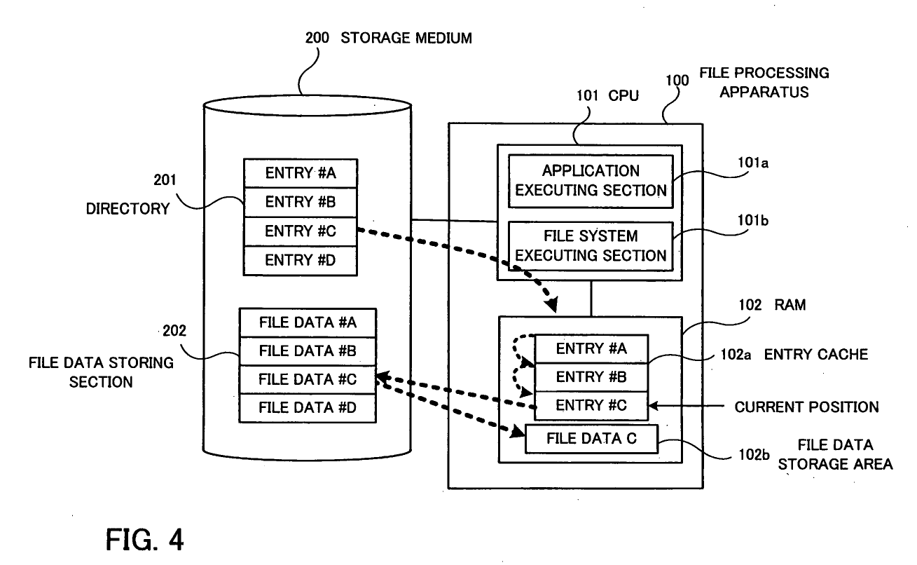

FIG. 4 shows operations of the file processing apparatus.

In the above-described file processing apparatus 100, the application executing section 101a executes an application program when receiving an image display request. Specifically, in order to retrieve a file to be displayed (hereinafter, referred to as an object file), the section 101a instructs the file system executing section 101b to obtain file information within the directory 201 (to refer to the directory).

The instructed file system executing section 101b performs processing for referring to the directory 201 to sequentially notify one by one the application executing section 101a of file information (a file name). At this time, from among the entries #A to #D stored in the directory 201, the file system executing section 101b reads out as many entries (three entries in FIG. 4) as the number of those storable in the entry cache 102a and temporarily stores the entries in the cache 102a. Further, the section 101b refers to the respective entries starting from the entry #A and notifies the application executing section 101a of file information as well as grasps a position of the entry to which the 101b currently refers (hereinafter, referred to as a current position). Thereafter, the application executing section 101a retrieves an object file based on the file information notified from the file system executing section 101b. When finding the name of a file to be retrieved, the section 101a instructs the section 101b to open a file whose information is most recently notified. The file system executing section 101b refers to an entry (identifier) of the current position that the system 101b grasps at that time, and then opens the file indicated by the entry. Thereafter, when the application executing section 101a instructs the file system executing section 101b to perform read/write of file data, the section 101b stores, in the file data storage area 102b, file data obtained based on the position of file data included in the identifier.

Next, the above-described processing will be described in detail with reference to a flowchart.

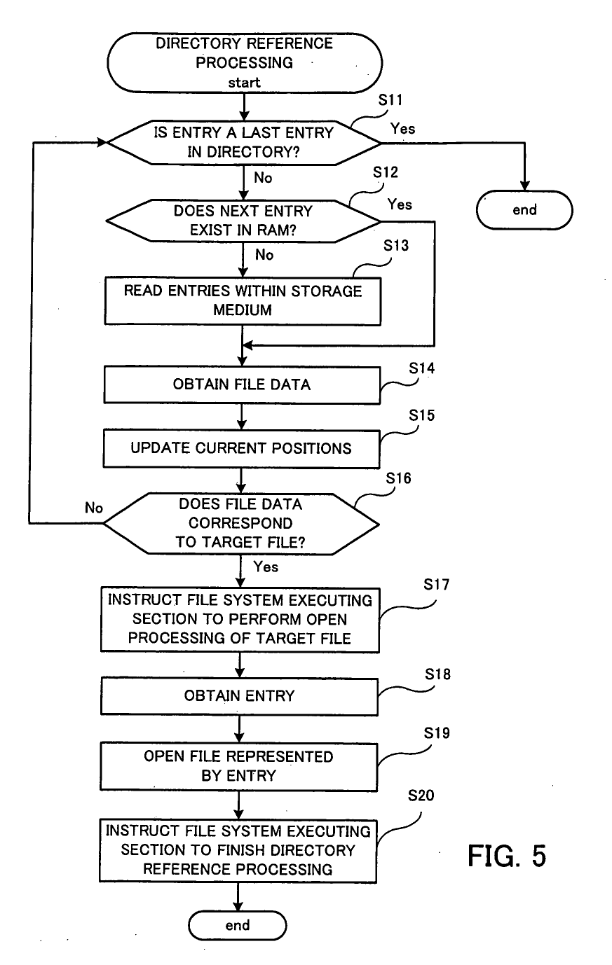

FIG. 5 is a flowchart showing directory reference processing and open processing of an object file.

First, the file system executing section 101b determines whether the entry is a last entry in the directory, for example, by referring to the presence or absence of a file name included in the entry (step S11).

When referring to the last entry (Yes in step S11), the section 101b completes the directory reference processing.

When referring to an entry other than the last entry (No in step S11), the file system executing section 101b determines whether the next entry exists in the RAM 102 by referring to the entry cache 102a (step S12).

When the next entry exists in the RAM 102 (Yes in step S12), the flow goes to step S14.

When the next entry does not exist in the RAM 102 (No in step S12), the file system executing section 101b reads as many entries within the storage medium 200 as the number of those storable in the entry cache 102a (step S13).

Next, the file system executing section 101b refers to the entries stored in the entry cache 102a to obtain file information (a file name) and notifies the application executing section 101a of the information (step S14).

Simultaneously, the file system executing section 101b updates the current position of the entry to which the section 101b refers within the entry cache 102a (step S15).

Next, the application executing section 101a determines based on the notified information whether the file is a file to be retrieved (object file) (step S16). This determination is performed based on, for example, whether a part of the file name stored in the ROM 103 is present in the file name included in the entry.

When the file is not an object file (No in step S16), the flow returns to step S11 and repeats the subsequent steps.

When the file is an object file (Yes in step S16), the application executing section 101a instructs the file system executing section 101b to perform open processing of the object file (step S17).

The file system executing section 101b obtains an entry of the current position (step S18).

Further, the section 101b opens a file indicated by the entry (step S19).

Finally, the application executing section 101a instructs the file system executing section 101b to complete the directory reference processing (step S20).

Next, description will be made on one example of a file-opening function (API) necessary for executing the open processing.

The file system executing section 101b supplies the application executing section 101a with a file-opening function (API) having the following specification.

fno=f(dno,mode)

This function specifies as an input parameter a directory descriptor used for the directory reference processing (dno) and a file open mode (mode).

The directory descriptor is a descriptor used for the directory reference, and internal information represented by this descriptor includes the current position of the entry. Further, in this function, the position of the most recently obtained entry can be found from the internal information represented by the directory descriptor specified as the input parameter. Therefore, information (the position of data) necessary for opening the file can be immediately referenced from the entry. Further, the most recently obtained entry exists as cache data in the entry cache 102a. Therefore, when opening the file indicated by the entry, an access to the storage medium 200 for the entry reference needs not be performed. As a result, the file can be opened at high speed.

Specifically, a function (opendir function) of starting the directory reference processing specifies a directory descriptor for an opened directory and, a readdir function having specified therein the directory descriptor reads entries one by one. Further, in this function, the directory descriptor specified in the readdir function is used to open a file indicated by the entry most recently read by the readdir function and to specify a file descriptor (fno) for the opened file. Thereafter, using the specified file descriptor, data input-output operations for a file corresponding to this file descriptor can be performed.

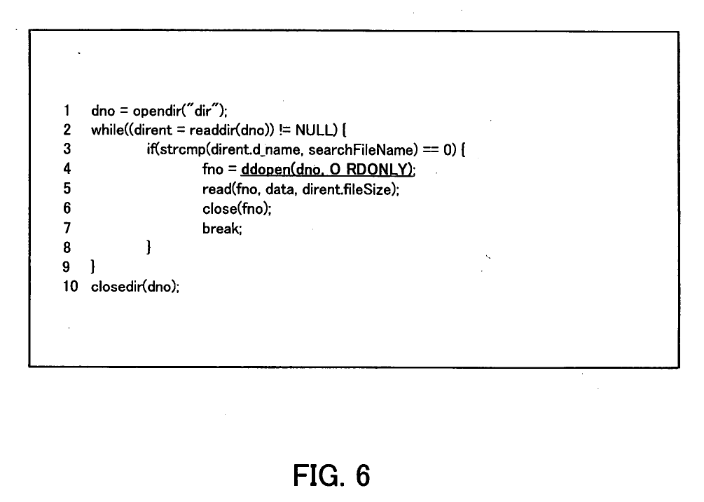

FIG. 6 shows a use image of a function.

First Line: start the directory reference processing (obtain dno as a directory descriptor).

Second Line: sequentially refer to file information within the directory. Obtain, on an entry-by-entry basis, file information included in the directory “dir”. After referring to all the entries, the process proceeds to a tenth line.

Third Line: determine whether the file name is a name stored in search File Name. When an object file is found, the process proceeds to a fourth line, whereas when an object file is not found, the process proceeds to the second line.

Fourth Line: Immediately open the file indicated by the most recently referred-to entry (obtain fno as a file descriptor).

Fifth Line: read the opened file.

Sixth Line: complete the input/output operations for the opened file.

Seventh Line: break the process. The process proceeds to the tenth line.

Tenth Line: complete the directory reference processing.

As described above, the file processing apparatus 100 according to the present embodiment reads entries within the directory 201 into the entry cache 102a, and sequentially refers to the entries one by one to retrieve an object file, whereby a file indicated by the entry (the most recently referred-to entry) of the found file can be opened at high speed. Thus, speeding up of the processing can be achieved.

Further, the above-described processing functions can be realized by slightly changing a program and therefore, the present embodiment can be easily applied to an existing file system.

Further, the present invention can be widely applied to embedded devices, for example, a portable remote terminal and portable audio player.

The computer-readable recording medium recording a file processing program, and file processing method and apparatus, and computer-readable recording medium recording a functional program of the present invention are described based on the shown embodiments. However, the present invention is not limited to these embodiments. The constitution of each part may be replaced with an arbitrary constitution having a similar function. In addition, other arbitrary constitutions and processes may be added to the present invention.

Further, the present invention may be a combination of two or more arbitrary constitutions (features) of the foregoing embodiments. The above-described processing functions can be realized by a computer. In that case, a program describing a processing content of the functions to be owned by the file processing apparatus 100 is provided. By executing the program on a computer, the above-described processing functions are realized on the computer. The program describing the processing content can be recorded on a computer-readable recording medium. Examples of the computer-readable recording medium include a magnetic recording system, an optical disk, a magnetooptical medium and a semiconductor memory. Examples of the magnetic recording system include a hard disk drive (HDD), a floppy disk (FD) and a magnetic tape. Examples of the optical disk include a digital versatile disc (DVD), a digital versatile disc-random access memory (DVD-RAM), a compact disc-read only memory (CD-ROM) and a compact disc-recordable/rewritable (CD-R/RW). Examples of the magnetooptical medium include a magneto-optical disk (MO).

In the case of distributing a program, portable recording media such as DVDs and CD-ROMs having recorded thereon the program are sold. Further, the program may be stored in a storage device of a server computer so as to be transferred from the server computer to another computer via a network. A computer that executes a file processing program stores in its own storage device, for example, a program recorded on a portable recording medium or a program transferred from a server computer. Then, the computer reads out the program from its own storage device and executes processing according to the program.

The present invention is constructed such that while keeping an identifier obtained by retrieval, a position of data is obtained from the identifier during the file open processing. Therefore, object data can be obtained by performing the retrieval of the identifier only once. As a result, processing for the object data can be performed at high speed.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A computer-readable recording medium recording a file processing program applied to a file system, the program causing a computer to function as:
notifying means which sequentially notifies, based on information acquisition instructions from an application, the application of a plurality of data blocks stored in storing means;
identifier grasping means which refers to identifiers of the respective data blocks stored in the storing means and grasps an identifier corresponding to a data block currently notified of by the notifying means; and
executing means which, when the notifying means notifies the application of the plurality of data blocks, receives data execution instructions from the application and reads out and executes a data block corresponding to an identifier most recently grasped by the identifier grasping means.

2. The computer-readable recording medium according to claim 1, wherein:
the program further causes the computer to function as temporarily storing means capable of storing at least one of the identifiers, and
the identifier grasping means grasps the identifier read in the temporarily storing means.

3. The computer-readable recording medium according to claim 1, wherein the storing means is detachably connected to the computer.

4. A file processing method applied to a file system executed by a computer, comprising the steps of:
causing notifying means to sequentially notify, based on information acquisition instructions from an application, the application of a plurality of data blocks stored in storing means;
causing identifier grasping means to refer to identifiers of the respective data blocks stored in the storing means and to grasp an identifier corresponding to a data block currently notified of by the notifying means; and
causing executing means to receive, when the notifying means notifies the application of the plurality of data blocks, data execution instructions from the application and to read out and execute a data block corresponding to an identifier most recently grasped by the identifier grasping means

5. A file processing apparatus applied to a file system, comprising:
notifying means which sequentially notifies, based on information acquisition instructions from an application, the application of a plurality of data blocks stored in storing means;
identifier grasping means which refers to identifiers of the respective data blocks stored in the storing means and grasps an identifier corresponding to a data block currently notified of by the notifying means; and
executing means which, when the notifying means notifies the application of the plurality of data blocks, receives data execution instructions from the application and reads out and executes a data block corresponding to an identifier most recently grasped by the identifier grasping means.

6. A computer-readable recording medium recording a functional program applied to a file system, the program causing a computer to function as:
outputting means which, in open processing executed in a state where based on information acquisition instructions from an application the application is sequentially notified of a plurality of data blocks stored in storing means, identifiers of the respective data blocks stored in the storing means are referenced and an identifier corresponding to a data block currently notified of to the application is grasped, outputs as a return value a data block corresponding to a most recently grasped identifier, the open processing executed based on a function call from the application when the application is sequentially notified of the plurality of data blocks.
